(19) United States
(12) Patent Application Publication
(10) Pub. No.: US 2023/0047115 A1
(43) Pub. Date: Feb. 16, 2023

(54) METHOD FOR COMPRESSING A SEQUENCE OF IMAGES DISPLAYING SYNTHETIC GRAPHICAL ELEMENTS OF NON-PHOTOGRAPHIC ORIGIN

(71) Applicants: SAFRAN DATA SYSTEMS, COURTABOEUF CEDE (FR); INSTITUT MINES-TELECOM, PALAISEAU (FR)

(72) Inventors: Marco CAGNAZZO, MOISSY-CRAMAYEL (FR); Attilio FIANDROTTI, MOISSY-CRAMAYEL (FR); Christophe RUELLAN, MOISSY-CRAMAYEL (FR)

(73) Assignees: SAFRAN DATA SYSTEMS, COURTABOEUF CEDEX (FR); INSTITUT MINES-TELECOM, PALAISEAU (FR)

(21) Appl. No.: 17/783,971

(22) PCT Filed: Dec. 10, 2020
(86) PCT No.: PCT/FR2020/052382

§ 371 Date: Jun. 9, 2022

(30) Foreign Application Priority Data
Dec. 10, 2019 (FR) 1914090

(51) Int. Cl. G06T 9/00; G06T 3/40; G06T 5/00

(52) U.S. Cl. CPC G06T 9/00; G06T 3/40; G06T 5/002; G06T 2207/20024

(57) ABSTRACT

Method for compressing a sequence of images comprising a first image and a second image, the method comprising the steps of: generating a first descriptor comprising parameters for displaying a computer-generated graphical element in the first image, the graphical element being of non-photographic origin, and the display parameters not comprising pixel values; processing the second image so as to determine an event which gave rise to a potential variation in the parameters for displaying the graphical element between the first image and the second image; generating a second descriptor comprising an event code indicating the determined event.

### FIELD OF THE INVENTION

This invention relates to the field of image processing.

The invention more particularly relates to a method for compressing a sequence of images.

### PRIOR ART

Videos displayed on screens found in an aircraft cockpit have specific features. The images of such videos show synthetic graphic elements (lines, polygons, circles, characters) overlaid on a background. The synthetic graphic elements are of non-photographic origin in the sense that their plotting has been entirely determined by a computer, and not by a camera or a video camera. In the example of an image of FIG. 1, the background is of photographic origin. In the example of an image of FIG. 2, the background is uniform, of non-photographic origin.

These videos must be compressed for transmission and storage.

In the article “Very Low Bitrate Semantic Compression of Airplane Cockpit Screen Content”, by lulia Mitrica and al. provision is made for a compression method wherein the synthetic graphic elements and the background of an image are compressed separately, to increase the compression rate of the image.

In particular, to encode a synthetic graphic element shown in an image, a descriptor is generated comprising display parameters of the synthetic graphic element in the image. The display parameters do not comprise any pixel values. The synthetic nature of the graphic element makes it possible to be able to visually describe this graphic element using fewer voluminous display parameters than all the values of the pixels occupied by this graphic element in the first image, and this with no losses.

Each image of a video is thus compressed in the same way, with specific descriptors for its synthetic graphic elements, and independent data for compressing the background of the image.

### SUMMARY OF THE INVENTION

An aim of the invention is to compress even more efficiently a sequence of images showing computer-generated graphic elements.

For this purpose provision is made, according to a first aspect, for a method for compressing a sequence of images comprising a first image and a second image, the method comprising steps of:
detecting in the first image or in the second image a computer-generated graphic element and a background on which the graphic element is overlaid,
generating a first descriptor comprising display parameters of a graphic element in the first image, the display parameters not comprising any pixel values,
processing the second image, such as to determine an event that has caused a potential variation in the display parameters of the graphic element between the first image and the second image,
generating a second descriptor comprising an event code indicating the determined event, wherein the steps of generating the first descriptor and the second descriptor are implemented independently of a compression of the background.

The first descriptor contains display parameters which are in themselves sufficient to plot a computer-generated graphic element. The second descriptor, meanwhile, indicates what has potentially changed with respect to the first descriptor. The second descriptor thus follow an incremental logic, and can hence be of much smaller size than the first descriptor.

As a consequence, the transmission bitrate of the data once compressed can be increased. In other words, for a constant transmission rate, data representing more images can be transmitted.

The method according to the first aspect may comprise the following features, taken alone or combined with one another when this is technically possible.

Preferably, the method moreover comprises the following steps:
modifying the image where the background has been detected such as to obtain a background image, the modification comprising a low-pass filter applied to pixel values of the image showing the computer-generated graphic element,
compressing the background image independently of the steps for generating the first descriptor and the second descriptor.

Preferably, when it is determined that the second image does not show the graphic element, the event code has a value indicating a disappearance of a synthetic graphic element.

Preferably, when it is determined that the second image shows the graphic element displaced with respect to the first image, the event code has a value indicating a displacement of a computer-generated graphic element.

Preferably, the second descriptor comprises positioning data making it possible, alone or in combination with the first descriptor, to determine a position of the graphic element in the second image.

Preferably, the position data comprise a vector of displacement between a position of the graphic element in the first image and a position of the graphic element in the second image.

Preferably, the method comprises a comparison between, on the one hand, the displacement of the graphic element between the first image and the second image, and, on the other hand, a predefined threshold, and wherein the event code has the value indicating a displacement only if said displacement of the graphic element is less than the predefined threshold.

Preferably, when it is determined that the second image shows a computer-generated graphic element that is different from a computer-generated graphic element shown in the first image, but which is occupying the same position, the event code has a value indicating a change of synthetic graphic element, and the second descriptor comprises data characterizing this change.

Preferably, when it is determined that the second image shows the graphic element unchanged with respect to the first image, the event code has a value indicating an absence of change of any graphic element.

Preferably, the display parameters are in themselves sufficient to allow the rendering of the graphic element as shown in the first image on the basis of said display parameters.

Alternatively, the image sequence moreover comprises an earlier image than the first image, and the first descriptor comprises an event code indicating an event that has caused a potential variation in the display parameters of the graphic element between the earlier image and the first image.

Preferably, the processing step is restricted to a portion of the second image.

Preferably, the processing step is implemented by a convolutional neural network.

Preferably, the synthetic element is a character, a polygon, a menu, a grid, or a part of a menu or of a grid.

Preferably, the background is of photographic origin.

Preferably, when the synthetic graphic element is a character, the first descriptor comprises a code specific to the character, and optionally a code providing information about a font in which the character is shown in the second image and/or a code providing information about a color of the character in the second image.

Provision is also made for a method for decompressing data obtained by the compressing method according to the first aspect.

Provision is also made for a computer program product comprising program code instructions for executing the steps of the method according to the first aspect, when this program is executed by a computer.

Provision is also made for a computer-readable memory storing instructions executable by the computer for executing the steps of the method according to the first aspect.

### DESCRIPTION OF THE FIGURES

Other features, aims and advantages of the invention will become apparent from the following description, which is purely illustrative and non-limiting, and which must be read with reference to the appended drawings wherein:

FIGS. 1 and 2 are two examples of images shown on a screen of an aircraft cockpit.

FIG. 3 schematically represents an image-processing device according to an embodiment.

FIG. 4 is a flow chart of steps of a method according to an embodiment of the invention.

FIGS. 5 and 6 are two examples of images able to be compressed by means of the method of FIG. 4.

FIG. 7 schematically represents a chain of descriptors generated for different images of a sequence of images.

In all the figures, the similar elements bear identical references.

### DETAILED DESCRIPTION OF THE INVENTION

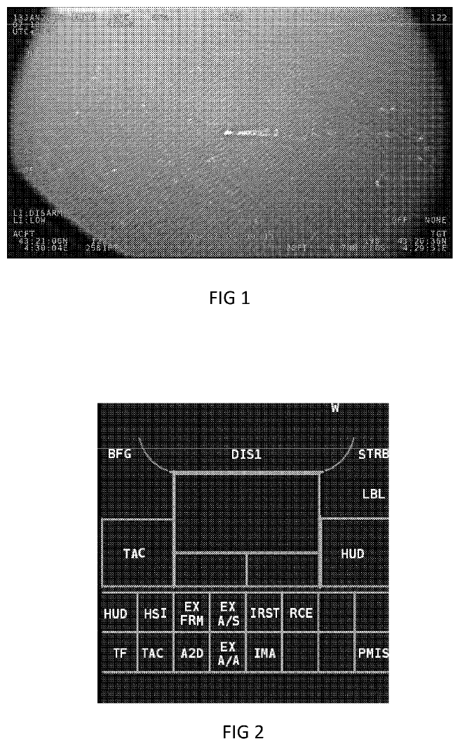

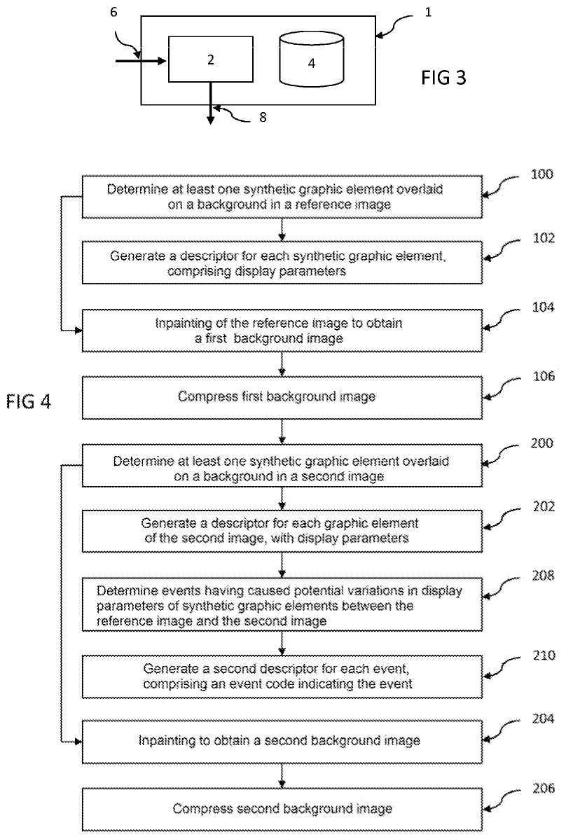

With reference to FIG. 1, a device 1 for processing a sequence of images comprises at least one processor 2 and a memory 4.

The processing device 1 comprises an input 6 for receiving a sequence of images to be compressed, or data to be decompressed.

The processor 2 is adapted to execute a compressing or decompressing program, this compressing program itself comprising program code instructions for executing a compressing or decompressing method which will now be described hereinafter.

The memory 4 is adapted to store data received by the input 6, as well as data generated by the processor 2. The memory 4 typically comprises at least one volatile memory unit 4 (RAM for example) and at least one non-volatile memory unit 4 (Flash drive, hard disk, SSD, etc.) to store data persistently.

The processing device 1 further comprises an output 8 through which are supplied data resulting from a compression or decompression implemented by the processor 2 executing the abovementioned program.

It is assumed that a sequence of images is received via the input 6 of the processing device 1 and stored in the memory 4.

Each image is a matrix of pixels, each pixel having a position which is specific to it, and color data. It is assumed in the remainder of the text that all the images of the sequence are of the same dimensions (height, width).

The images of the sequence typically show a background, which may be of photographic origin, or non-photographic origin.

The images may show synthetic graphic elements overlaid on the background.

As stated in the background section, the synthetic graphic elements are graphic elements generated by a computer. In accordance with the usual meaning given it in the literature, a computer-generated graphic element is by definition of non-photographic origin. Specifically, their plotting is entirely determined by a computer, and not by a camera or a video camera.

A synthetic graphic element may for example be: a character, a polygon, a menu, a grid, or a part of a menu or of a grid. These synthetic elements are regular in the sense that they have been exactly plotted using a finite number of display parameters which are not pixel values.

For example, in the case of a character, this character may be defined by the following display parameters: a character code, a code providing information about the font of a character, and a code providing information about a color of the character. All these codes are used to plot the character in an image. It will be understood that the character is of any kind: it may be an alphanumeric character or any other symbol (punctuation, arrow, mathematical symbol etc.)

When the graphic element is a menu, a grid or a part of a menu or of a grid, the graphic element is composed of a finite number of straight or curved segments.

Each synthetic graphic element occupies a certain number of pixels in an image of the sequence.

With reference to the flow chart of FIG. 4, a method for compressing the image sequence implemented by the device 1 comprises the following steps.

The processor 2 processes a first image of the sequence, such as to analyze the content thereof (step 100). In the remainder of the text, this first image will be referred to as the “reference image”.

The processing implemented in step 100 detects any of the following elements in the reference image: its background, and any synthetic graphic element overlaid on this background. The term “any” should be understood to mean that the processor 2 can detect the absence of graphic elements in the reference image, or that it can detect the presence of at least one such element.

To determine which synthetic graphic elements are present in the reference image, the processor 2 can be based on a library of predefined synthetic graphic elements. More precisely, the processor 2 compares the contents of an area of the reference image with an element of the library, and estimates a probability of a match between the compared elements. If this probability if greater than a predefined threshold, the processor 2 considers that the element of the library is indeed shown in the area of the reference image. Otherwise, the processor 2 repeats the same steps based on another element of the library. The processor 2 concludes that no graphic element is shown in the reference image insofar as it reaches the end of the dictionary, without the predefined threshold having been crossed.

Alternatively, this step 100 is implemented by a convolutional neural network. This neural network has been previously trained to be able to recognize the different elements of the dictionary. The convolutional neural network does not operate according to a sequential logic, which has the advantage of quick execution, once the learning is completed.

In the remainder of the text, it is assumed that the processor 2 has determined in step 100 the presence of at least one synthetic graphic element in the reference image.

Advantageously, the step 100 is restricted to a portion of the reference image. In this text, a “portion” of an image is not necessarily contiguous. This portion may comprise one or more predefined areas, each predefined area having each a predefined position, size and shape (for example rectangular). These predefined areas may be connected or disjointed in the reference image, but do not cover the entirety of the reference image. This restriction is an advantage, since it makes it possible to limit the computing load devoted to the determination of synthetic graphic elements. This restriction does not pose any drawbacks when it is known in advance where any graphic elements may exist.

For each synthetic graphic element founded in the reference image, the processor 2 generates a descriptor associated with the synthetic graphic element (step 102). This descriptor comprises display parameters of the synthetic graphic element in the reference image.

The display parameters do not comprise any pixel values. The synthetic nature of the graphic element makes it possible to visually describe this graphic element using less voluminous display parameters than all the values of the pixels occupied by this graphic element in the reference image.

The descriptor is the result of a lossless encoding of the synthetic graphic element which is associated with it, in the sense that the display parameters give information allowing a rendering of the graphic element in accordance with the original.

The display parameters of a synthetic graphic element comprise data indicating the position of the graphic element in the reference image. These position data typically comprise a pair of coordinates in the image (vertical coordinate v, and horizontal coordinate h).

The display parameters comprise at least one additional parameter, in addition to the position data. The number of additional parameters depends on the nature of the first synthetic element, which can be more or less complex.

Let us take, for example, the case where the synthetic graphic element is a character. In this case, the display parameters of this graphic element comprise a code specific to the character (ASCII code for example, or another code). This character code may be the only additional display parameter in addition to the position data, in the first descriptor.

The character code can be completed by:
a code of the font to be used to display the character (e.g. Arial, Times, etc.).
a code providing information about the color of the character. It should be noted that this code is an item of global information which does not solely pertain to one pixel of the first graphic element, but pertains to this graphic element in its entirety. This code can be representative of a uniform color, or representative of a color gradient, etc.

In another embodiment, the code of the font and the color code are predefined, in the sense that the processing device knows in advance that the character which is found in the predefined area must of necessity have a predefined font and color. It is therefore not in this case necessary to encode these items of information in the descriptor.

The preceding steps are repeated where applicable for each synthetic graphic element found in the reference image, such as to produce a plurality of descriptors, each descriptor pertaining to a synthetic graphic element of the reference image.

In the remainder of the text, the descriptors thus generated are referred to as descriptors of “intra” type. The descriptors of “intra” type contain information in itself sufficient to make it possible to plot a synthetic graphic element represented in an image (here the reference image).

The plurality of descriptors of “intra” type is stored in the memory 4 in the form of a table, each row of the table being one of the descriptors of “intra” type.

FIG. 5 shows an example of a first image, containing different synthetic graphic elements, all of which are characters. From this example image the table 1 of descriptors of “intra” type shown below is obtained.

TABLE 1

| Row | Character | v | h | p |
|---|---|---|---|---|
| 1 | A | 30 | 20 | 0 |
| 2 | B | 30 | 28 | 0 |
| 3 | C | 30 | 36 | 0 |
| 4 | D | 30 | 44 | 0 |
| 5 | E | 30 | 52 | 0 |
| 6 | F | 30 | 100 | 0 |
| 7 | G | 30 | 108 | 0 |
| 8 | H | 30 | 116 | 0 |
| 9 | 1 | 40 | 20 | 0 |
| 10 | 2 | 40 | 28 | 0 |
| 11 | 3 | 40 | 36 | 0 |
| 12 | 4 | 40 | 44 | 0 |
| 13 | 5 | 40 | 52 | 0 |
| 14 | Z | 70 | 20 | 0 |
| 15 | Y | 70 | 28 | 0 |
| 16 | X | 70 | 36 | 0 |
| 17 | W | 70 | 44 | 0 |

In this example, the descriptor of “intra” type generated for the character “A” located on the top left of the reference image is the second row of the table 1. This descriptor comprises: the code of the character “A”, the vertical position v=30 of the character (corresponding to a row number of the reference image), the horizontal position h=20 of the character (corresponding to a column number of the reference image), and a font code p, here of value equal to zero. It is observed that these parameters suffice to allow the subsequent exact rendering of the graphic element “A”, though without these comprising any pixel values. This is why the “intra” descriptors above are lossless.

The other rows of the table 1 contain the same display parameters, making it possible to display other characters located in the reference image shown in FIG. 5.

The processor 2 moreover implements an inpainting process, which modifies the reference image such as to obtain a background image (step 104). To obtain this background image, the processor 2 replaces the pixel values of the reference image occupied by the synthetic graphic elements detected by other pixel values suitable for reducing, or even eliminating high spatial frequencies in the spectrum of the reference image. This replacement of pixel values is therefore a low-pass filter applied to the pixels of the reference image. The spectrum of the modified image therefore comprises fewer components at high frequencies than the spectrum of the reference image before the inpainting process.

Such a low-pass filtering can typically be obtained by computing the mean of the pixel values of the background connected to pixels of the synthetic graphic elements.

Suppose for example that the reference image contains synthetic graphic elements in black, and that the background is white, as is the case for the image of FIG. 5. In this case, the inpainting process can replace the black pixels of the synthetic graphic elements with white pixels, which makes it possible to obtain a completely white background image.

Let us take as another example another image containing synthetic graphic elements of character type being of a white color with black outlines, overlaid on a background of photographic origin in grayscale, such as for example the image of FIG. 1. In this case, the inpainting process can replace the white and black pixels of the synthetic graphic elements of character type by the mean of the pixel values of the background.

The modified image resulting from the inpainting process is then compressed by the processor 2 according to a known method of the prior art, for example the HEVC method (step 106). This compression 106 is independent from the steps of generating the descriptors associated with the synthetic graphic elements. The compression 106 can be done alongside the step 102, before it or after it.

Finally, the synthetic graphic elements of the reference image and the background of the reference image are compressed separately in the steps 102 and 106.

The sequence of images received moreover contains a second image, which is subsequent to the reference image in the sequence. The second image can immediately follow the reference image in the sequence, or not.

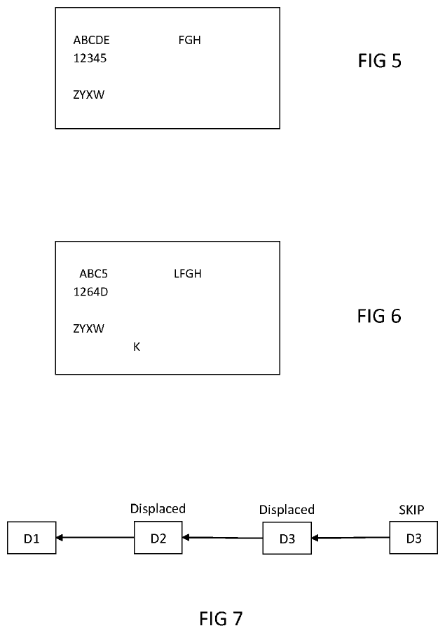

FIG. 6 shows an example of a second image. The contents of this second image has varied with respect to the reference image. For example, the graphic element “A” previously discussed no longer occupies exactly the same place. Certain synthetic graphic elements replace others. Some graphic elements have disappeared, and others have appeared (for example the character K).

The processor 2 implements steps 200, 202, 204, 206 which are respectively identical to steps 100, 102, 104, and 106 previously described, but applied to the second image.

In particular, at the end of step 202 a plurality of new descriptors of “intra” type is obtained, of the same format as the descriptors of “intra” type generated for the reference image, but containing potentially different values. The table formed by the plurality of new descriptors of “intra” type generated for the example of the second image of FIG. 6 is as follows.

TABLE 2

| Row | Character | v | h | p |
|---|---|---|---|---|
| 1 | A | 30 | 28 | 0 |
| 2 | B | 30 | 36 | 0 |
| 3 | C | 30 | 44 | 0 |
| 4 | 5 | 30 | 52 | 0 |
| 5 | L | 30 | 82 | 0 |
| 6 | F | 30 | 100 | 0 |
| 7 | G | 30 | 108 | 0 |
| 8 | H | 30 | 116 | 0 |
| 9 | 1 | 40 | 20 | 0 |
| 10 | 2 | 40 | 28 | 0 |
| 11 | 6 | 40 | 36 | 0 |
| 12 | 4 | 40 | 44 | 0 |
| 13 | D | 40 | 52 | 0 |
| 14 | Z | 70 | 20 | 0 |
| 15 | Y | 70 | 28 | 0 |
| 16 | X | 70 | 36 | 0 |
| 17 | W | 70 | 44 | 0 |
| 18 | K | 80 | 68 | 0 |

For example, it has been previously stated that the character A has changed position in the second image shown in FIG. 6, by comparison with the reference image shown in FIG. 5. This position change is embodied by a new descriptor of “intra” type generated for the second image, and containing different position data from those entered in the descriptor of “intra” type pertaining to A and generated for the reference image (here, the horizontal position h has gone from 20 to 28). On the other hand, the character A has not changed font; the font code p is therefore the same as the two descriptors pertaining to the character A of the reference image and of the second image, respectively.

However, the compression of the synthetic graphic elements of the second image is not yet complete at this stage, unlike what has been done for the reference image.

The processor 2 determines an event that has caused a potential variation in the display parameters of a synthetic graphic element between the reference image and the second image (step 208).

The processor 2 generates a second descriptor associated with the second image, comprising an event code indicating the determined event, and which will be referred to in the remainder of the text as a descriptor of “inter” type (step 210).

The processor 2 repeats these two steps 208, 210 for each graphic element found in the reference image or in the second image (so referenced in a descriptor of “intra” type generated for the reference image or for the second image, after steps 102 and/or 202).

A plurality of descriptors of “inter” type is thus obtained, each pertaining to a synthetic graphic element of the reference image or of the second image. The plurality of descriptors of “inter” type forms a table, each descriptor being a row of the table.

Once all the descriptors of “inter” type have been generated, the “intra” descriptors for the second image can be deleted from the memory 4.

A descriptor of “inter” type does not have the same format as a descriptor of “intra” type. As previously indicated, a descriptor of “intra” type contains display parameters which are in themselves sufficient to plot a synthetic graphic element. A descriptor of “inter” type meanwhile indicates what has potentially changed with respect to a descriptor of “intra” type, which allows the descriptor of “inter” type to be much less voluminous than an “intra” descriptor for different types of events which will be detailed further on.

A descriptor of “inter” type may comprise a cross-reference to the reference image, making it possible to locate the first image in the image sequence. This cross-reference for example takes the form of a separation in position between the first image and the second image in the sequence of images. For example, in the case where the second image immediately follows the first image in the sequence, this separation has a value of 1. In the event of there being one or more intermediate images between the first image and the second image, this separation would be an integer strictly greater than 1. This then means that the table of intra descriptors of the first image has been retained as reference for the second image rather than choosing the table of intra descriptors of one of the intermediate images.

The inclusion of such a cross-reference in a descriptor of “inter” type does however remain optional. Specifically, it may be envisioned that a descriptor of “inter” type implicitly cross-references to the image that immediately precedes the second image in the sequence of images.

Alternatively or additionally, provision can also be made for including in a descriptor of “inter” type a cross-reference to the first image solely in the case where the first image does not immediately precede the second image in the sequence of images.

A descriptor of “inter” type may further comprise a cross-reference to a descriptor of “intra” type of the reference image. This cross-reference can designate the number of the row of the descriptor in the table of descriptors generated for the reference image, when the “inter” descriptor modifies the “intra” descriptor which is referenced therein.

However, here again, a cross-reference to a descriptor of “intra” type is not obligatory in a descriptor of “inter” type. It can specifically be done so that the descriptor of “inter” type occupies the same table row as the “intra” type descriptor that it modifies. In this case, it is the positions of the descriptors in their respective tables that makes it possible to implicitly deduce the logic mapping from one to another.

Finally, there is still a logical relationship from an “inter” descriptor to an “intra” descriptor, but this logical relationship can be explicit or implicit in the “inter” descriptor.

Besides the event code (and any cross-references to an image and/or a descriptor mentioned above), a descriptor of “intra” type can comprise additional data, which depend on the determined event.

Below is a table of descriptors of “inter” type obtained for the second image of FIG. 6.

TABLE 3

| Row | Event code | Additional data |
|---|---|---|
| 1 | Displaced | δx = 8, δy = 0 |
| 2 | Displaced | δx = 8, δy = 0 |
| 3 | Displaced | δx = 8, δy = 0 |
| 4 | SKIP | — |
| 5 | Changed | Code = 5 |
| 6 | NEW | Code = L, v = 80, h = 68, p = 0 |
| 7 | Unchanged | — |
| 8 | Unchanged | — |
| 9 | Unchanged | — |
| 10 | Unchanged | — |
| 11 | Unchanged | — |
| 12 | Changed | Code = 6 |
| 13 | Unchanged | — |
| 14 | Changed | Code = D |
| 15 | Unchanged | — |
| 16 | Unchanged | — |
| 17 | Unchanged | — |
| 18 | Unchanged | — |
| 19 | NEW | Code = K, v = 80, h = 68, Font = 0 |

Different types of determinable events and the contents of the descriptor of “inter” type generated in each of these cases will now be presented.

Absence of Change of a Synthetic Graphic Element

Take the case of a graphic element which has been found in the first image at a given position.

When it is determined that the second image shows the first graphic element, in a way unchanged with respect to the first image (i.e. at the same position and with strictly the same rendering), the event code included in the “inter” type descriptor has a value “Unchanged” indicating an absence of change of the first graphic element between the first image and the second image.

To detect the case, the processor 2 can simply identify that the two tables of “intra” type descriptors respectively generated for the first image and for the second image contain one and the same identical descriptor.

Displacement of a Synthetic Graphic Element

In another case, a synthetic graphic element has been found by the processor 2 in the first image at a certain position, and has also been found by the processor 2 in the second image, but at a different position (the display parameters of this synthetic graphic element other than its position being moreover identical in the first image and in the second image).

To detect this case of displacement, the processor 2 can identify that the two tables of “intra” type descriptors generated respectively for the first image and for the second image contain two descriptors which differ from one another solely by their position data.

This case is in particular applicable to the character A shown in the two example images of the FIGS. 5 and 6.

In this case of displacement, the descriptor of “inter” type generated comprises position data making it possible, alone or in combination with the “intra” descriptor to which it refers, to determine a position of the synthetic graphic element in the second image.

These position data typically comprise a displacement vector between the position of the synthetic graphic element in the first image and the position of the graphic element in the second image. The displacement vector typically comprises a horizontal component δx, and a vertical component δy. This displacement vector is computed as a separation between the position between the graphic element in the first image and the position of the graphic element in the second image.

Preferably, the descriptor of “inter” type is filled with the displacement code “Displaced” (and the abovementioned associated data) on condition that the displacement of the graphic element is less than a predefined threshold. If not, another event code is used (see the other cases set out below).

Disappearance of a Synthetic Graphic Element

Let us now consider the case where the processor 2 determines that the second image no longer shows a synthetic graphic element which was shown in the first image.

To detect this case, the processor 2 identifies that the plurality of descriptors of “intra” type generated for the second image contains a descriptor for a synthetic graphic element, but that the plurality of descriptors of “intra” type generated for the first image does not contain such a descriptor.

In this case, the event code has a value SKIP indicating the disappearance of the first synthetic graphic element.

As seen previously, the event code “Displaced” indicating a displacement of a synthetic graphic element is used on condition that the displacement undergone by a graphic element between the first image and the second image is less than a predetermined threshold.

When this condition is not met, a descriptor of “inter” type pertaining to the disappeared graphic element is generated with the code SKIP.

Change of Synthetic Graphic Element in the Same Position

The case will now be considered wherein the processor 2 determines that the first image and the second image respectively show two different synthetic graphic elements at the same position.

This difference can be of various natures. It can in particular be a different in shape and/or color. In the case of characters, a character may replace another character, between the first image and the second image.

In practice, the processor 2 detects this case when it observes that one and the same position is referenced in a descriptor of “intra” type generated for the first image and also in a new descriptor of “intra” type generated for the second image, but that these two descriptors have at least one parameter, the values of which differ (other than the position).

During such a detection, the processor 2 includes in the second descriptor an event code “Changed” having a value indicating a change of the first synthetic graphic element between the first image and the second image.

In this case, the second descriptor also comprises data which characterize this change. If the first descriptor and the new descriptor comprising the same position comprise other unchanged display parameters, these are not included in the second descriptor. In other words, only the display parameters modified between the first image and the second image are included in the second descriptor.

For example, the example first image shown in FIG. 5 shows the character E at the position (v=30, h=52), whereas the example second image shown in FIG. 6 shows the character 5 in this same position. The two characters E and 5 are shown in the same font. The font code p of zero value being already present in the descriptor of “intra” type associated with the character E, it is not necessary to repeat it in the descriptor of “inter” type associated with the character 5. The same case of change is applicable to the character 3 of the first image, replaced by the character 6 in the second image.

Appearance of a New Graphic Element

In another case, the processor 2 can detect that a graphic element is present in the second image but not the first image.

In this case, a descriptor of “inter” type is generated comprising an event code having a value NEW indicating the appearance of a new synthetic graphic element. The same display parameters are associated with this code that are found in the “intra” descriptors previously described, which are in themselves sufficient to plot the graphic elements concerned by these descriptors.

By way of illustration, the characters K, L which appear in the example second image of FIG. 6 are each encoded as new characters, using the code “NEW”.

As previously seen, the event code “Displaced” indicating the displacement of a synthetic graphic element is used on condition that the displacement undergone by a graphic element between the first image and the second image is less than a predetermined threshold. When this condition is not met, a descriptor of “inter” type pertaining to the appeared graphic element is generated with the code NEW.

To summarize, the events identified during the step 208 are as follows: appearance, disappearance, change in the same place, displacement, absence of change.

The event code of a descriptor of “inter” type can therefore be encoded only on 3 bits.

Alignment of the “Intra” and “Inter” Descriptors

In the table below, the following are shown side-by-side: the “intra” descriptors generated for the first image, the “intra” descriptors generated for the second image by repeating the same steps, and the “inter” descriptors generated for the second image.

TABLE 4

| First image | | | | Second image | | | | Second image | |
|---|---|---|---|---|---|---|---|---|---|
| “Intra” descriptors | | | | “Intra” descriptors | | | | “Inter” descriptors | |
| Char. | v | h | p | Char. | v | h | p | Event code | Additional data |
| A | 30 | 20 | 0 | A | 30 | 28 | 0 | Displaced | δx = 8, δy = 0 |
| B | 30 | 28 | 0 | B | 30 | 36 | 0 | Displaced | δx = 8, δy = 0 |
| C | 30 | 36 | 0 | C | 30 | 44 | 0 | Displaced | δx = 8, δy = 0 |
| D | 30 | 44 | 0 | | | | | SKIP | — |
| E | 30 | 52 | 0 | 5 | 30 | 52 | 0 | Changed | Code = 5 |
| | | | | L | 30 | 88 | 0 | NEW | Code = L, v = 80, h = 68, p = 0 |
| F | 30 | 100 | 0 | F | 30 | 100 | 0 | Unchanged | — |
| G | 30 | 108 | 0 | G | 30 | 108 | 0 | Unchanged | — |
| H | 30 | 116 | 0 | H | 30 | 116 | 0 | Unchanged | — |
| 1 | 40 | 20 | 0 | 1 | 40 | 20 | 0 | Unchanged | — |
| 2 | 40 | 28 | 0 | 2 | 40 | 28 | 0 | Unchanged | — |
| 3 | 40 | 36 | 0 | 6 | 40 | 36 | 0 | Changed | Code = 6 |
| 4 | 40 | 44 | 0 | 4 | 40 | 44 | 0 | Unchanged | — |
| 5 | 40 | 52 | 0 | D | 40 | 52 | 0 | Changed | Code = D |
| Z | 70 | 20 | 0 | Z | 70 | 20 | 0 | Unchanged | — |
| Y | 70 | 28 | 0 | Y | 70 | 28 | 0 | Unchanged | — |
| X | 70 | 36 | 0 | X | 70 | 36 | 0 | Unchanged | — |
| W | 70 | 44 | 0 | W | 70 | 44 | 0 | Unchanged | — |
| | | | | K | 80 | 68 | 0 | NEW | Code = K, v = 80, h = 68, p = 0 |

As can be seen on reading the table 4 above, the “inter” descriptors with the event codes SKIP and/or NEW are used such that the other “inter” descriptors are found aligned with the intra descriptors to which they refer, which makes it possible, as indicated above, to not necessarily include any explicit referencing of descriptors in the “inter” descriptors.

In the appendix, at the end of this description, is an example of pseudo-code for implementing the compressing method. Here is the significance of different variables used in this pseudo-code:
ref and cur: Tables including NL rows. Each row storing [Horizontal position, Vertical position, character code, color]
Δ_x_allowed: Horizontal maximum displacement threshold
Δ_y_allowed: Vertical maximum displacement threshold
Event NEW: code 001 & position & character code
Event CHANGED: code 011 & character code
Event UNCHANGED: code 1
Event SKIP: code 000
Event DISPLACED: code 010 & (displacement_x or displacement_y)

Iteration of the “Inter” Encoding

In the preceding description, it has been assumed that a descriptor of “inter” type generated for the second image during the step 210 cross-references to a descriptor of “intra” type of the first image, i.e. a descriptor comprising display parameters in themselves sufficient to allow the rendering of the corresponding graphic element as shown in the reference image.

However, this is not at all obligatory: a descriptor of “inter” type can cross-reference to another descriptor of “inter” type.

Steps 200, 202, 208, 210 can specifically be repeated on a third image, this time taking the second image as the reference image. During the step 210 implemented on the third image, a descriptor of “inter” type is generated which cross-references to an “inter” descriptor generated for the second image, which itself cross-references to an “intra” descriptor generated for the first image.

The processor 2 finally processes the video by iteratively repeating the processing described above image by image. It therefore generates following the initial “intra” descriptor, a chronological sequence of “inter” descriptors which successively modify the synthetic elements where applicable, in turn. This iteration then creates a chain of “inter” tables referenced from the last to the original intra table. This chain can have several branches when the cross-reference is done to an earlier table than that of the preceding image. At any time, the processor 2 can also choose to “refresh” the image, i.e. transmit a new “intra” descriptor which serves as a new reference to the subsequent “inter” descriptors.

By way of example illustrating this chaining, FIG. 7 shows descriptors D1 to D7 generated for different images of one and the same sequence of images, and all pertaining to the same synthetic graphic element.
The descriptor D1 is a descriptor of “intra” type.
The descriptor D2 is a descriptor of “inter” type which cross-references to the descriptor D1 and which comprises the event code “Displaced” to indicate that the synthetic graphic element has been displaced, with respect to the position entered into the descriptor D1.
The descriptor D3 is a descriptor of “inter” type which cross-references to the descriptor 2, and which signals an absence of change of the graphic element (via the event code “Unchanged”).
The descriptor D4 is a descriptor of “inter” type which also cross-references to the descriptor D2 and which still comprises the event code “Displaced” to indicate that the graphic element has been displaced again, with respect to what is entered into the descriptor D2.
The descriptor D6 is a descriptor of “inter” type which signals the disappearance of the synthetic graphic element via the event code SKIP.
The descriptor D1 is a descriptor of “intra” type»for a synthetic graphic element in the same position as that concerned by the descriptors D1 to D6.

The interest of the compression mechanism increases when a majority of inter tables and a minority of intra tables are sent, since the overall gain in compression of the video has then increased.

Decompression

The descriptors generated and the data resulting from the background compressions together form a set of output data encoding the image sequence, and in a compressed manner since the output data flow is less voluminous than the sequence of images.

The output data flow obtained by the processing device 1 can be decompressed by this same device 1 or a device of the same type with a view to obtaining an image sequence in accordance with the original sequence.

This decompression method comprises steps symmetrical to those implemented during the compression method described hereinabove. First of all, the receiver unambiguously identifies the chronological sequence of the images and of the tables of descriptors associated with each one.

In particular, to restore a graphic element of the current image (to be displayed) and described in a descriptor of “inter” type, the processor identifies the initial descriptor of “intra” type to which refer the prior chain of descriptors of “inter” type refer, which results in the current image, and uses the display parameters recorded in this descriptor of “intra” type, modified by the sequence of any additional information recorded in the descriptors of “inter” type constituting this chain.

### OTHER EMBODIMENTS

It is understood that the method described above is applicable to any type of synthetic graphic element, of non-photographic origin, and not only to characters. For example, the display parameters which can be generated for a circle comprise a position, a radius, and where applicable other optional parameters (line thickness, line color etc.). This principle can of course be generalized to other geometrical shapes.

In the text above an embodiment has been disclosed wherein all the descriptors of “inter” type generated for the second image refer to descriptors of “intra” type generated for the same image, namely the first image. It is possible that groups of descriptors of “inter” type generated for one and the same image modify descriptors describing images different from one another. In this case, each descriptor of “inter” type must contain an explicit image reference image.

APPENDIX
Example of a pseudo-code to implement the compression method

```
LI_R = 0
LI_C = 0
counter_movement_block_H = 0
counter_movement_block_W = 0
while LI_R < NL_R
  c_letter = cur(LI_C)
  r_letter = ref(LI_R)
  if r_letter.position ≃ c_letter.position
    if r_letter.label = c_letter.label
      // Unchanged
      bitstream = write1bit(1)
    else
      // Changed
      bitstream = write3bit(011)
      bitstream = write6bit(c_letter.label)
    LI_C = LI_C + 1
    LI_R = LI_R + 1
  elseif r_letter.x ≃ c_letter.x and |r_letter.y − c_letter.y| ∈ [0,
Δ_y_allowed] and r_letter.label = c_letter.label
    // Displaced Y
    displacement_y = r_letter.y − c_letter.y)
    LI_C = LI_C + 1
    LI_R = LI_R + 1
    bitstream = write3bit(010)
    bitstream = write6bit(displacement_y − 1)
  elseif r_letter.y ≃ c_letter.y and |r_letter.x − c_letter.x| ∈ [0,
Δ_x_allowed] and r_letter.label = c_letter.label
    // Displaced X
    displacement_x = r_letter.y − c_letter.y
    LI_C = LI_C + 1
    LI_R = LI_R + 1
    bitstream = write3bit(010)
    bitstream = write6bit(displacement_x − 1)
  elseif |r_letter.x − c_letter.x| > Δ_x_allowed or |r_letter.y −
c_letter.y| > Δ_y_allowed and r_letter.label! = c_letter.label
    while |r_letter.x − c_letter.x| > Δ_x_allowed or |r_letter.y −
  c_letter.y| > Δ_y_allowed and r_letter.label! = c_letter.label
      // New
      bitstream = write3bit(001)
      bitstream = write11bit(c_letter.x)
      bitstream = write11bit(c_letter.y)
      bitstream = write6bit(c_letter.label)
      LI_C = LI_C + 1
  else
    // Skip
    bitstream = write3bit(000)
    LI_R = LI_R + 1
```

1. A method of compressing a sequence of images comprising a first image and a second image, the method comprising:
detecting in the first image or in the second image a computer-generated graphic element and a background on which the graphic element is overlaid,
generating a first descriptor comprising display parameters of the graphic element in the first image, the display parameters not comprising any pixel values,
processing the second image, such as to determine an event that has caused a potential variation in the display parameters of the graphic element between the first image and the second image,
generating a second descriptor comprising an event code indicating the event, wherein the steps of generating the first descriptor and the second descriptor are implemented independently of a compression of the background.

2. The method as claimed in claim 1, further comprising:
modifying an image being one of the first image and the second image wherein the background has been detected, such as to obtain a background image, wherein modifying the image comprises applying a low-pass filter to pixel values of the image which show the computer-generated graphic element,
compressing the background image independently of generating the first descriptor and the second descriptor.

3. The method as claimed in claim 1, wherein:
when it is determined that the second image does not show the computer-generated graphic element, the event code has a value indicating a disappearance.

4. The method as claimed in claim 1, wherein:
when it is determined that the second image shows the computer-generated graphic element displaced with respect to the first image, the event code has a value indicating a displacement.

5. The method as claimed in claim 4, wherein the second descriptor comprises positioning data allowing to determine, alone or in combination with the first descriptor, a position of the computer-generated graphic element in the second image.

6. The method as claimed in claim 5, wherein the positioning data comprise a vector of displacement between a position of the computer-generated graphic element in the first image and a position of the computer-generated graphic element in the second image.

7. The method as claimed in claim 4, comprising comparing a displacement of the computer-generated graphic element with a threshold, wherein the event code has the value indicating a displacement only if said displacement of the computer-generated graphic element is less than the threshold.

8. The method as claimed in claim 1, wherein:
when it is determined that the second image shows a graphic element that is different from the computer-generated graphic element shown in the first image, but which is occupying a same position, the event code has a value indicating a change of synthetic graphic element, and the second descriptor comprises data characterizing said change.

9. The method as claimed in claim 1, wherein:
when it is determined that the second image shows the graphic element unchanged with respect to the first image, the event code has a value indicating an absence of change.

10. The method as claimed in claim 1, wherein the display parameters are in themselves sufficient to allow a rendering of the computer-generated graphic element as shown in the first image on the basis of said display parameters.

11. The method as claimed in claim 1, wherein the image sequence further comprises a prior image located upstream the first image in the image sequence, and wherein the first descriptor comprises an event code indicating an event that has caused a potential variation in the display parameters of the computer-generated graphic element between the prior image and the first image.

12. The method as claimed in claim 1, wherein processing the second image is restricted to a portion of the second image.

13. The method as claimed in claim 1, wherein processing the second image is implemented by a convolutional neural network.

14. The method as claimed in claim 1, wherein the computer-generated element is a character, a polygon, a menu, a grid, or a part of a menu or of a grid, and/or wherein the background is of photographic origin.

15. The method as claimed in claim 1, wherein the synthetic graphic element is a character, and wherein the first descriptor comprises a code specific to the character.

16. The method of claim 15, wherein the first descriptor comprises a code providing information about a font in which the character is shown in the second image.

17. A non-transitory computer-readable medium storing instructions causing the computer to perform the method as claimed in claim 1.

18. The method of claim 15, wherein the first descriptor comprises a code providing information about a color of the character in the second image.
